(19) United States
(12) Patent Application Publication
(10) Pub. No.: US 2012/0300126 A1
(43) Pub. Date: Nov. 29, 2012

(54) ELECTRONIC APPARATUS AND TV PHONE METHOD

(75) Inventor: Yuji Takao, Akishima-shi (JP)

(73) Assignee: KABUSHIKI KAISHA TOSHIBA, Tokyo (JP)

(21) Appl. No.: 13/399,568

(22) Filed: Feb. 17, 2012

(30) Foreign Application Priority Data
May 26, 2011 (JP) 2011-117807

(51) Int. Cl. H04N 7/00

(52) U.S. Cl. 348/468; 348/552; 348/E07.001; 348/E07.033

(57) ABSTRACT

According to one embodiment, an electronic apparatus includes a first microphone, a first communication module, selecting module and a second communication module. The first microphone inputs first audio. The first communication module is configured to receive first video and second audio which is input by a second microphone from a first electronic apparatus. The selecting module is configured to select either the first microphone or the second microphone. The second communication module is configured to transmit, to a second electronic apparatus, the first audio or the second audio, and the first video which is input from the first electronic apparatus, and to receive second video and third audio from the second electronic apparatus. The first communication module is configured to transmit the second video and the third audio to the first electronic apparatus.

### CROSS-REFERENCE TO RELATED APPLICATIONS

This application is based upon and claims the benefit of priority from prior Japanese Patent Application No. 2011-117807, filed May 26, 2011, the entire contents of which are incorporated herein by reference.

### FIELD

Embodiments described herein relate generally to an electronic apparatus which inputs/outputs video and audio and a TV phone method.

### BACKGROUND

In recent years, an electronic apparatus, such as a personal computer or a mobile phone, is usable as a TV phone. The electronic apparatus is equipped with a camera and a microphone. When a TV phone function has been executed, the electronic apparatus transmits video and audio, which have been input from the camera and microphone, to some other electronic apparatus, which is a telephone call counterpart, via a communication network. In addition, the electronic apparatus displays, on a display, video which has been received from the other electronic apparatus via the communication network, and outputs audio, which has been received, from a speaker. A TV phone is realized by mutually transmitting/receiving video and audio between the electronic apparatuses.

In this prior art, when the electronic apparatus, such as a personal computer or a mobile phone, is used as a TV phone, the display screen of the display is small. Thus, even if a TV phone call is made, the video of the telephone call counterpart can be viewed on only the small screen. Consequently, a realistic sensation, which should normally be given by the TV phone, would be lost. In addition, when the TV phone is used by a plurality of speakers at the same time, the disposition of the TV phone has to be taken into account so that each speaker may fall within the range of photographing of the camera and the speech of each speaker may be input by the microphone. In this respect, the usability is not good.

Besides, it has been thought that a TV apparatus (TV receiver) with a large display screen is used for a TV phone. However, a remote controller has to be used in order to operate the TV apparatus. In general, in an operation using a remote controller, it is not easy to execute various settings and character input for using the TV apparatus as the TV phone, leading to poor usability.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating a TV phone system using an electronic apparatus according to an embodiment.

FIG. 2 is an exemplary block diagram illustrating the structure of the TV phone system of the embodiment.

FIG. 3 is an exemplary flow chart illustrating a microphone setup process in the embodiment.

FIG. 4 is an exemplary view illustrating a microphone setup screen in the embodiment.

FIG. 5 is an exemplary flow chart illustrating a TV phone process in the embodiment.

FIG. 6 is an exemplary flow chart illustrating the TV phone process in the embodiment.

FIG. 7 is an exemplary view illustrating the state in which the TV phone system of the embodiment is used.

FIG. 8 is an exemplary view illustrating the screen in the embodiment.

FIG. 9 is an exemplary block diagram illustrating the structure of the TV phone system in the embodiment.

### DETAILED DESCRIPTION

Various embodiments will be described hereinafter with reference to the accompanying drawings.

In general, according to one embodiment, an electronic apparatus comprises a first microphone, a first communication module, selecting module and a second communication module. The first microphone inputs first audio. The first communication module is configured to receive first video and second audio which is input by a second microphone from a first electronic apparatus. The selecting module is configured to select either the first microphone or the second microphone. The second communication module is configured to transmit, to a second electronic apparatus, the first audio or the second audio, and the first video which is input from the first electronic apparatus, and to receive second video and third audio from the second electronic apparatus. The first communication module is configured to transmit the second video and the third audio to the first electronic apparatus.

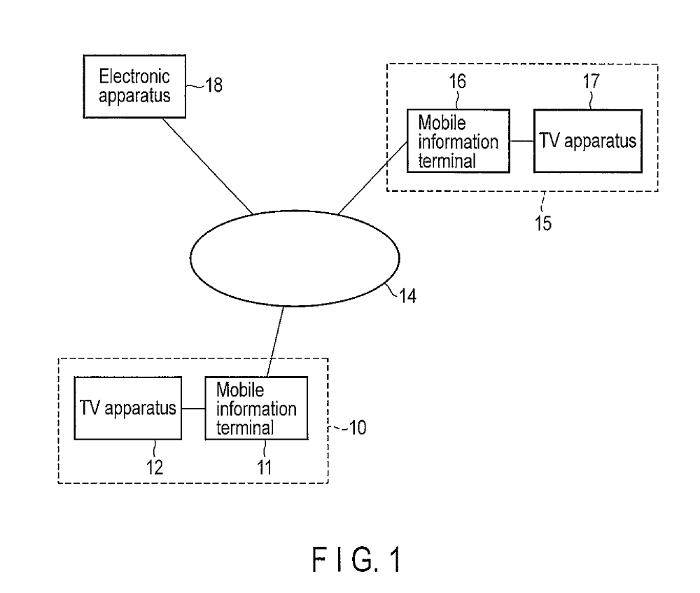

FIG. 1 illustrates an example of a TV phone system 10 using an electronic apparatus according to an embodiment. In this embodiment, a TV phone is realized by the electronic apparatus. Examples of the electronic apparatus include a mobile information terminal 11 such as a mobile phone, a smartphone or a tablet terminal, an information processing apparatus such as a personal computer, and a TV apparatus 12 which is equipped with a communication function.

In FIG. 1, the TV phone system 10 is composed of the mobile information terminal 11 and TV apparatus 12. The TV phone system 10 realizes a TV phone function of transmitting/receiving video and audio with a telephone call counterpart (a TV phone system 15, an electronic apparatus 18) which is connected via a network 14. The network 14 includes a wireless telephone network, the Internet, etc. The TV phone system 15, like the TV phone system 10, is composed of a mobile information terminal 16 and a TV apparatus 17. The electronic apparatus 18 is realized by, e.g. a personal computer which is equipped with a TV phone function.

The TV phone system 10 is connected, by means of the mobile information terminal 11, to the TV phone system 15 or electronic apparatus 18, which is a telephone call counterpart, via the network 14. The mobile information terminal 11 controls a telephone call with the TV phone system 15 or electronic apparatus 18. The mobile information terminal 11 outputs received video and audio, which are transmitted from the telephone call counterpart, to the TV apparatus 12. In addition, the mobile information terminal 11 transmits video, which is input from the TV apparatus 12, and audio, which is input by the microphone provided in the mobile information terminal 11 or TV apparatus 12, to the TV phone system 15 or electronic apparatus 18 which is the telephone call counterpart. The mobile information terminal 11 realizes a TV phone function by mutual transmission/reception of video and audio between itself and the electronic apparatus that is the telephone call counterpart. In addition, the mobile information terminal 11 has a basic input operation function as an information processing terminal, and provides a man-machine interface which enables a user to easily execute various setup operations and text input operations.

The TV apparatus 12 is a general TV receiver which receives TV broadcast and outputs it. The TV apparatus 12 has a TV phone function in cooperation with the mobile information terminal 11, in addition to a TV broadcast output function. When executing the TV phone function, the TV apparatus 12 outputs video and audio, which have been input from the telephone call counterpart via the mobile information terminal 11. In addition, the TV apparatus 12 is provided with a microphone and a speaker. The TV apparatus 12 can input voice, which is uttered by the speaker while the TV phone function is being executed, and video, which is captured within a predetermined range including the speaker, and can output the voice and video to the mobile information terminal 11.

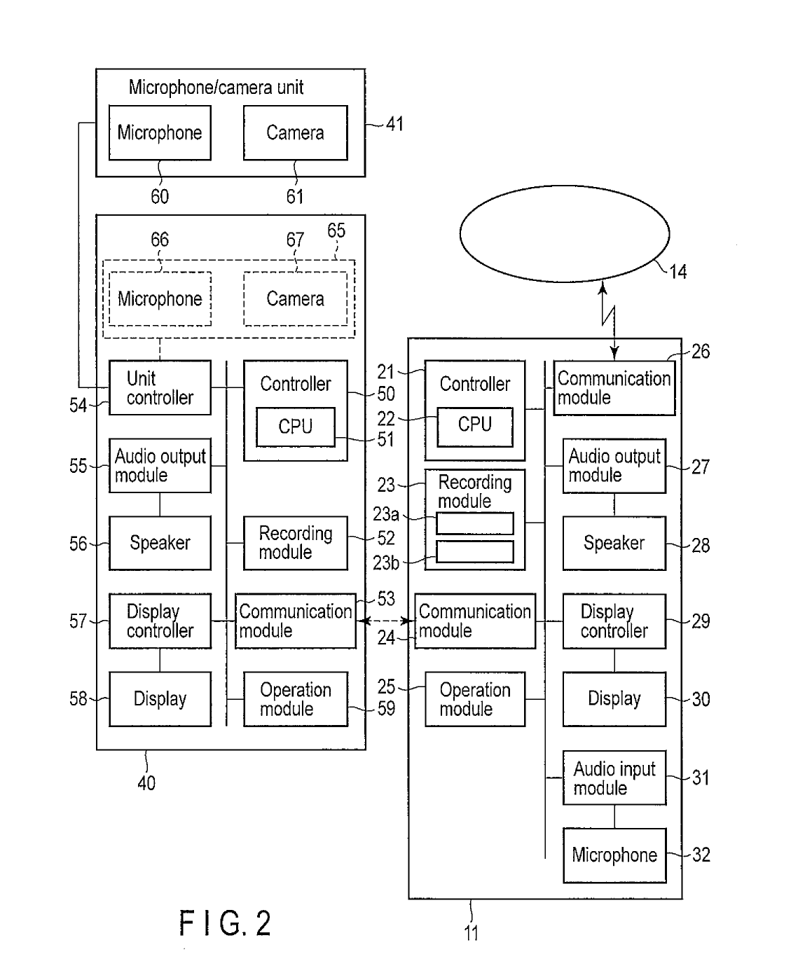

FIG. 2 is an exemplary block diagram illustrating the structure of the TV phone system 10 (mobile information terminal 11, TV apparatus 12) of the embodiment.

As shown in FIG. 2, the mobile information terminal 11 includes a controller 21 (CPU 22), a recording module 23, a communication module 24, an operation module 25, a communication module 26, an audio output module 27, a speaker 28, a display controller 29, a display 30, an audio input module 31, and a microphone 32.

The controller 21 controls the entirety of the mobile information terminal 11. The controller 21 executes, by the CPU 22, a basic program (Operating System) and various applications which are recorded in the recording module 23, thereby controlling the respective components and realizing various functions. The application programs include a TV phone program for realizing the TV phone function in cooperation with the TV apparatus 12.

The recording module 23 is composed of a memory or the like, and records various programs and various data. In the recording module 23, for example, a TV phone program 23a and various data (including microphone setup data 23b to be described later) for controlling the TV phone function are recorded.

The communication module 24 controls communication with the TV apparatus 12. The communication module 24 communicates with the TV apparatus 12 (communication module 53), thereby to transmit/receive video and audio. The communication module 24 may execute communication using a generally used IP (Internet protocol) network, or may execute communication using wireless communication technology. As a technique for transmitting/receiving video and audio, use may be made of, for example, techniques which are based on DLNA (Digital Living Network Alliance) guideline for transmission with use of an IP network, or based on Wireless HD (Wireless High Definition).

The operation module 25 is configured to input data corresponding to user operations. The operation module 25 inputs data via input devices such as buttons, a keyboard, and a touchpad.

The communication module 26 controls a connection to the network 14 by wireless communication.

The audio output module 27, under the control of the controller 21, causes the speaker 28 to output audio.

The display controller 29, under the control of the controller 21, causes the display 30 to display video, text, etc.

The audio input module 31 inputs, via the microphone 32, for example, voice uttered by the speaker.

On the other hand, the TV apparatus 12, as shown in FIG. 2, is composed of a TV apparatus body 40 and a microphone/camera unit 41.

The TV apparatus body 40 includes a controller 50 (CPU 51), a recording module 52, a communication module 53, a unit controller 54, an audio output module 55, a speaker 56, a display controller 57, a display 58, and an operation module 59. The microphone/camera unit 41 is provided with a microphone 60 and a camera 61.

The controller 50 (CPU 51) controls the entirety of the TV apparatus 12. The controller 50 executes, by the CPU 51, a basic program (Operating System) and various applications which are recorded in the recording module 52, thereby controlling the respective components and realizing various functions. The application programs include a TV phone program for realizing the TV phone function in cooperation with the mobile information terminal 11.

The recording module 52 is composed of a memory or the like, and records various programs and various data. In the recording module 52, for example, a TV phone program and various data for controlling the TV phone function are recorded.

The communication module 53 controls communication with the mobile information terminal 11. The communication module 53 communicates with the mobile information terminal 11 (communication module 24), thereby to transmit/receive video and audio. The communication module 53 may execute communication using a generally used IP network, or may execute communication using wireless communication technology. As a technique for transmitting/receiving video and audio, use may be made of, for example, techniques which are based on DLNA guideline for transmission with use of an IP network, or based on Wireless HD (Wireless High Definition).

The unit controller 54 controls the microphone/camera unit 41, and receives video and audio from the microphone/camera unit 41. The unit controller 54 is connected to the microphone/camera unit 41 via, for example, a USB (Universal Serial Bus) cable. In the meantime, the unit controller 54 may be configured to be connected to the microphone/camera unit 41 via, for example, a signal line other than the USB cable.

The audio output module 55, under the control of the controller 50, causes the speaker 56 to output audio.

The display controller 57, under the control of the controller 50, causes the display 58 to display video, text, etc.

The operation module 59 is configured to input data corresponding to user operations. The operation module 59 inputs data via, e.g. buttons or a remote controller.

The microphone/camera unit 41 is provided with the microphone 60 and camera 61. The microphone/camera unit 41 outputs the audio, which is input by the microphone 60, and the video, which is captured by the camera 61, to the TV apparatus body 40 (unit controller 54). The microphone/camera unit 41 is used, for example, when the TV phone function is executed. Since the microphone 60 is used for the TV phone, the microphone 60 has such capabilities as to be able to input sound in a relatively wide range. Thus, the microphone 60 can input voices of a plurality of speakers who are present in the vicinity of the TV apparatus 12. In addition, since the camera 61 is used for the TV phone, the camera 61 is attached such that the camera 61 has a range of photographing in a direction opposed to the display surface of the display 58. In short, the camera 61 is configured to be able to photograph a speaker who is viewing an image of the telephone call counterpart displayed on the display 58. In FIG. 2, the microphone/camera unit 41 is configured as a unit separate from the TV apparatus body 40. However, the microphone/camera unit 41 may be configured as a microphone/camera unit 65 which is built in the TV apparatus body 40. The microphone/camera unit 65 includes a microphone 66 and a camera 67.

Next, the operation of the TV phone system 10 in the embodiment is described.

The TV phone system 10 in this embodiment can be used as a TV phone by causing the mobile information terminal 11 and TV apparatus 12 to cooperate with each other. In the TV phone, a captured video image of a speaker and voice uttered by the speaker can be transmitted/received to/from a telephone call counterpart via the network 14. In addition, in the TV phone system 10, voice alone, or video alone, can be transmitted/received to/from the telephone call counterpart. Besides, in the TV phone system 10 in this embodiment, a text chat by text alone can be performed by inputting text data to the mobile information terminal 11 in accordance with a user operation and transmitting/receiving the text data to/from the counterpart. The mobile information terminal 11 can execute a text chart in parallel, while executing the TV phone function.

Since the mobile information terminal 11 has a basic input operation function as an information processing terminal, the mobile information terminal 11 can input characters more easily than the TV apparatus 12. Thus, when a text chat is performed, the mobile information terminal 11 can easily perform character input and various setting operations. On the other hand, since the TV apparatus 12 is provided with the display 58 which has a larger screen than the display 30 provided on the mobile information terminal 11, the TV apparatus 12, when used as the TV phone, displays the video image of the communication counterpart and outputs voice, thereby giving a better realistic sensation to the user. Specifically, the mobile information terminal 11 performs setting of the TV phone system 10 and executes operations of text chats, and the TV apparatus 12 outputs video and audio at the time of executing the TV phone function. Thereby, the user can make use of the advantageous features of the two kinds of electronic apparatuses. Thus, the TV phone system 10 with high usability is realized.

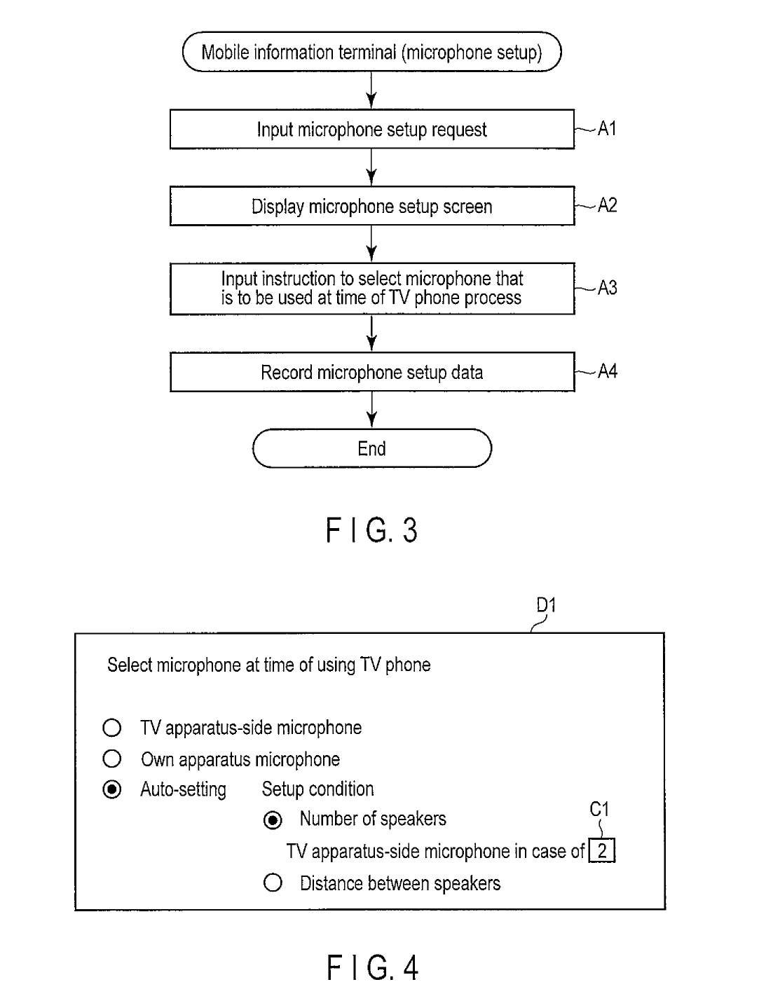

Referring to a flow chart of FIG. 3, a description is given of a microphone setup process for setting up the microphone which is used for audio input in the TV phone system 10 in the present embodiment.

In the TV telephone system 10 of this embodiment, when the TV phone function is executed, the speaker operates the mobile information terminal 11. Thus, the distance between the mobile information terminal 11 and the speaker is basically shorter than the distance between the TV apparatus 12 and the speaker. In general, an echo tends to easily occur when the distance between a microphone and a loud speaker becomes smaller than the distance between the microphone and a speaker (talker). Accordingly, the occurrence of an echo can be more suppressed in the case of inputting the speaker's voice with use of the microphone 32 of the mobile information terminal 11, than in the case of using the microphone 60 of the TV apparatus 12 (microphone/camera unit 41).

On the other hand, when a plurality of speakers use the TV phone system 10 at the same time, it becomes difficult to collect the speech of a speaker, who is distant from the mobile information terminal 11, by the microphone 32 of the mobile information terminal 11. Since the use of the microphone 32 of the mobile information terminal 11 hinders a smooth telephone conversion, the use of the microphone 60 of the microphone/camera unit 41, which can collect voices of the plural speakers with uniform loudness, is made usable.

When the TV phone function is executed, the mobile information terminal 11 can execute microphone setting for selecting either the microphone 32 of the mobile information terminal 11 or the microphone 60 of the TV apparatus 12.

When a microphone setup request has been input from the operation module 25 in accordance with a user operation (block A1), the controller 21 of the mobile information terminal 11 controls the display controller 29 to cause the display 30 to display a microphone setup screen (block A2).

FIG. 4 is an exemplary view illustrating an example of a microphone setup screen D1 in the embodiment. On the microphone setup screen D1 shown in FIG. 4, one of “TV apparatus-side microphone”, “Own apparatus microphone” and “Auto-setting” can be set.

In accordance with a user operation on the operation module 25, the controller 21 inputs an instruction to select the microphone that is to be used for the TV phone, and displays the setup state on the microphone setup screen D1 (block A3). The microphone setup screen D1 shown in FIG. 4 displays the setup state in which “Auto-setting” is selected.

In the meantime, “TV apparatus-side microphone” indicates that the microphone 60 of the microphone/camera unit 41 is used, and “Own apparatus microphone” indicates that the microphone 32 of the mobile information terminal 11 is used. The “Auto-setting” indicates that the number of speakers or the positional relationship between speakers (the distance between speakers) is determined based on the video captured by the camera 61 of the TV apparatus 12 (and the audio input by the microphone 60) and, based on the result of the determination, either the microphone 32 of the mobile information terminal 11 or the microphone 60 of the TV apparatus 12 is automatically switched and used. By selecting the “Auto-setting”, automatic control is executed so as to make either the microphone 32 of the mobile information terminal 11 or the microphone 60 of the TV apparatus 12 usable for the TV phone in accordance with the condition of use of the TV phone. Therefore, the usability for the speakers can be improved.

When the “Auto-setting” has been selected, either “Number of speakers” or “Distance between speakers” can be set as a setup condition.

The “Number of speakers” indicates that the microphone 60 of the TV apparatus 12 is used when the number of speakers is a preset number of speakers or more. When the “Number of speakers” has been set, the number of speakers can be input to an input field C1 in accordance with a user operation. As a default value, “2” is input. Specifically, when the number of speakers is plural, the TV phone function can be executed by using the microphone 60 of the TV apparatus 12. When the number of speakers is one, the TV phone function can be executed by using the microphone 32 of the mobile information terminal 11. The number of persons, which is “3” or more, can also be input to the input field C1. For example, when “3” has been input to the input field C1, the TV phone function can be executed by using the microphone 60 of the TV apparatus 12 if the number of speakers is three or more, and the TV phone function can be executed by using the microphone 32 of the mobile information terminal 11 if the number of speakers is two or less.

The “Distance between speakers” indicates that when the number of speakers is plural, either the microphone 32 of the mobile information terminal 11 or the microphone 60 of the TV apparatus 12 is switched and used, based on the distance between the speakers. For example, the “Distance between speakers” indicates that when it is determined that the distance between the remotest speakers is less than a predetermined preset value, the microphone 32 of the mobile information terminal 11 is used, and when it is determined that the distance between the speakers is the preset value or more, the microphone 60 of the TV apparatus 12 is used. Specifically, even when there are a plurality of speakers, if the voices of all speakers can be input by the microphone 32 of the mobile information terminal 11 because they are close to each other, the microphone 32 of the mobile information terminal 11 is preferentially used so that the occurrence of an echo may be suppressed.

The mobile information terminal 11 has the basic input operation function as the information processing terminal, and can easily perform a setup operation on the microphone setup screen D1.

If the setup operation on the microphone setup screen D1 is completed and the end of the microphone setup is instructed, the controller 21 records the microphone setup data 23b, which is indicative of the setup content on the microphone setup screen D1, in the recording module 23 and terminates the process (block A4). The microphone setup data 23b is referred to in a TV phone process (to be described later), in order to switch the microphone that is used for the TV phone.

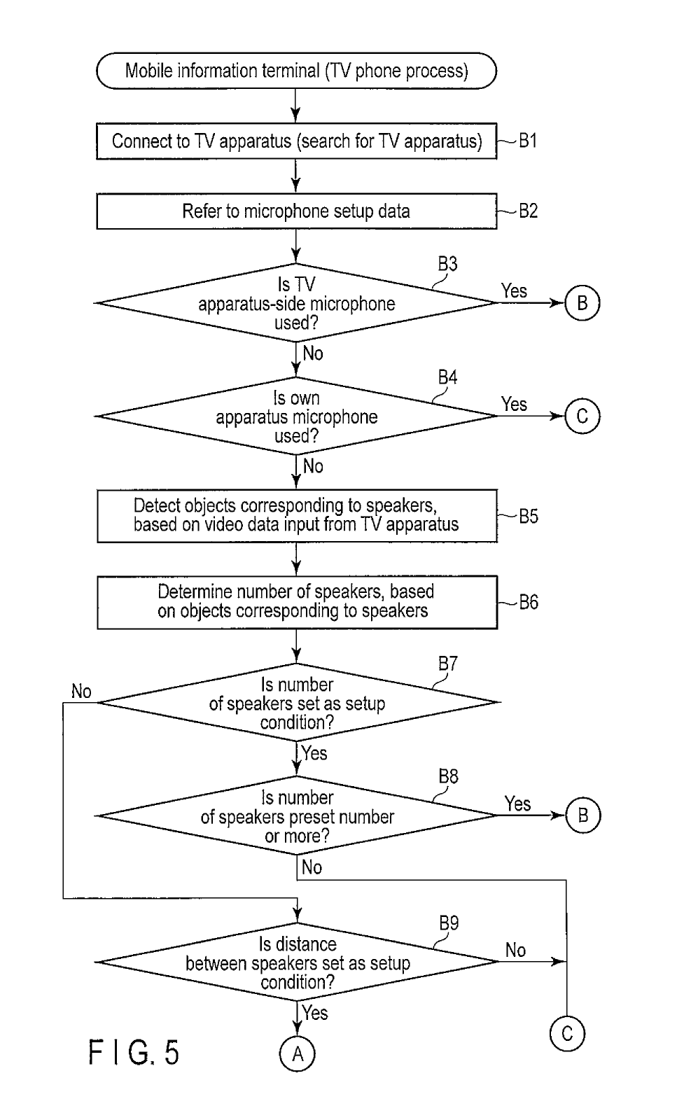

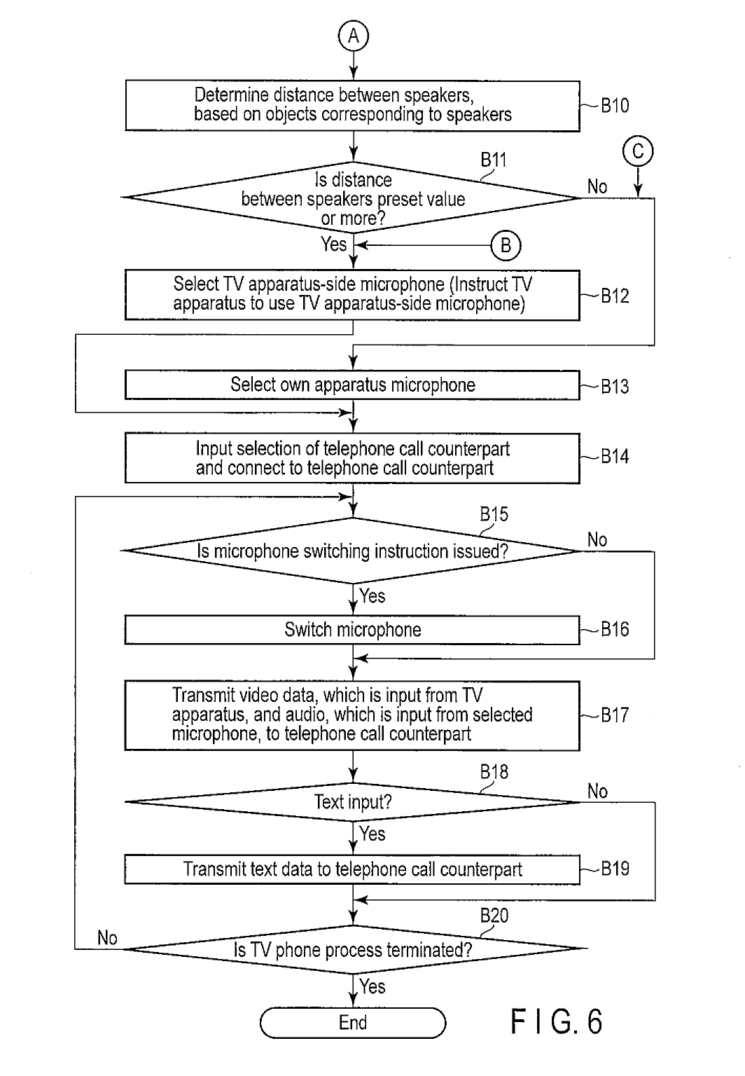

Next, referring to flow charts of FIG. 5 and FIG. 6, a description is given of a TV phone process of the mobile information terminal 11 in the embodiment.

To begin with, when a TV phone is used, the start of the TV phone process is instructed from, for example, the menu of the mobile information terminal 11. When the start of the TV phone process has been instructed, the controller 21 (CPU 22) starts the TV phone process corresponding to the TV phone program 23a.

In order to configure the TV phone system 10, the controller 21 searches for the TV apparatus 12 by the communication module 24. When the communication module 24 of the mobile information terminal 11 and the communication module 53 of the TV apparatus body 40 communicate with each other by the IP network, the communication module 24 acquires the IP address of the TV apparatus body 40 (communication module 53) and connects to the communication module 53 (block B1). The controller 21 records the IP address of the TV apparatus body 40, which has been acquired via the communication module 24. When the IP address is recorded, the controller 21 can directly connect to the TV apparatus 12 by using the IP address.

If connected to the TV apparatus 12, the controller 21 instructs the TV apparatus body 40 to start the TV phone function. The controller 50 of the TV apparatus body 40 starts the TV phone function in accordance with the instruction from the mobile information terminal 11, and instructs the microphone/camera unit 41 to input video and audio. The microphone/camera unit 41 starts the input of audio by the microphone 60 and the input of video by the camera 61, and outputs the audio and video to the TV apparatus body 40. The controller 50 causes the display 58 to display the video which is input from the microphone/camera unit 41 via the unit controller 54, and transmits the video to the mobile information terminal 11 via the communication module 53.

Next, the controller 21 executes setup of the microphone which is used for the TV phone, by referring to the microphone setup data 23b which is recorded in the recording module 23. When the use of “TV apparatus-side microphone” is set in the microphone setup data 23b (Yes in block B3), the controller 21 instructs, via the communication module 24, the TV apparatus 12 to use the microphone 60, thereby to use the audio, which is input from the microphone 60 of the TV apparatus 12, for the TV phone (block B12). In accordance with the instruction from the mobile information terminal 11, the controller 50 of the TV apparatus 12 executes control to transmit, together with the video, the audio, which is input from the microphone 60, to the mobile information terminal 11 via the communication module 53.

On the other hand, when the use of “Own apparatus microphone” is set in the microphone setup data 23b (Yes in block B4), the controller 21 executes control to input audio from the microphone 32 via the audio input module 31, thereby to use the audio, which is input from the microphone 32 provided in the own apparatus, for the TV phone (block B13).

When “Auto-setting” is set in the microphone setup data 23b (No in block B4), the controller 21 detects an object corresponding to a speaker, based on the video that is input from the TV apparatus 12, thereby to switch the microphone in accordance with the setup condition (block B5). For example, the controller 21 detects an area (object) corresponding to the face of a person from the video that is captured by the camera 61 of the TV apparatus 12. The face of a person can relatively easily be detected from the video, since the arrangement of the eyes, nose and mouth is estimated in advance. An already known technique can be used as the method for detecting the area corresponding to the face of the person.

In usual cases, when the TV phone is used by using the TV apparatus 12, the face of the speaker is directed to the TV apparatus 12 so that the speaker may view the video displayed on the TV apparatus 12. Accordingly, by setting the range of capturing video by the camera 61 in the direction opposed to the display surface of the display 58 of the TV apparatus 12, it is possible to input video including the face of the speaker and to detect the face of the person from the video. The controller 21 determines the number of speakers, based on the number of areas corresponding to the faces detected from the video (block B6).

In the above description, the face of a person is detected from the video. However, other objects corresponding to speakers may be detected. For example, when objects, which are varying in the video, are detected, it may be assumed that speakers are present, and the number of speakers may be determined based on the number of objects which are varying. In addition, when objects corresponding to a plurality of speakers overlap, the objects of individual speakers may be distinguished based on the difference in color of the objects (e.g. the colors of clothes of speakers). Other conventional techniques can be used as the method of determining the number of speakers.

When “Number of speakers” is set as the setup condition of the microphone setup data 23b (Yes in block B7), the controller 21 determines whether the number of speakers, which has been determined based on the video received from the TV apparatus 12, is a preset number or more, which is set in the microphone setup data 23b. When the number of speakers is the preset number or more (Yes in block B8), the controller 21 instructs, via the communication module 24, the TV apparatus 12 to use the microphone 60, thereby to use the audio, which is input from the microphone 60 of the TV apparatus 12, for the TV phone (block B12). Thereby, for example, when there are a plurality of speakers, the voice of each speaker can be input by the microphone 60 of the TV apparatus 12.

In accordance with the instruction from the mobile information terminal 11, the controller 50 of the TV apparatus 12 executes control to transmit, together with the video, the audio, which is input from the microphone 60, to the mobile information terminal 11 via the communication module 53.

On the other hand, when the number of speakers is not the preset number of more (No in block B8), the controller 21 executes control to input audio from the microphone 32 via the audio input module 31, thereby to use the audio, which is input from the microphone 32 provided in the own apparatus, for the TV phone (block B13). Thereby, for example, when the number of speakers is one, the voice of the speaker can be input by the microphone 32 of the mobile information terminal 11. By using the microphone 32 of the mobile information terminal 11 for the TV phone, the occurrence of an echo can be suppressed.

When “Distance between speakers” is set as the setup condition of the microphone setup data 23b (Yes in block B9), the controller 21 determines the distance between speakers, based on the objects corresponding to speakers, which are detected from the video received from the TV apparatus 12 (block B10). For example, the controller 21 detects objects corresponding to speakers from the video received from the TV apparatus 12, and calculates the distance between speakers, based on the sizes of areas corresponding to the faces of the objects or the positional relationship between the objects in the video.

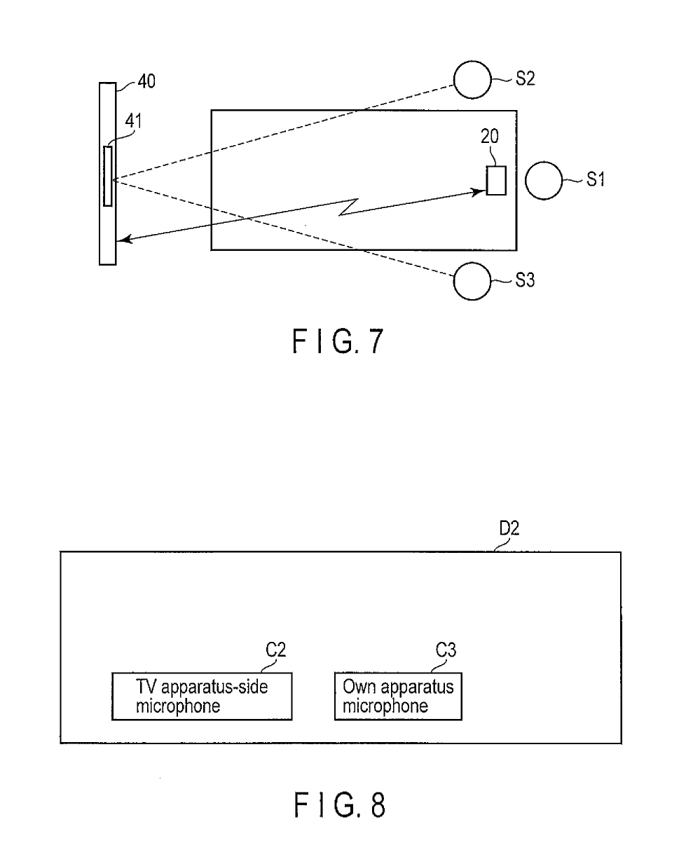

FIG. 7 is an exemplary view illustrating an example of the state in which the TV phone system 10 of the embodiment is used.

FIG. 7 shows that three speakers S1, S2 and S3 sit in a manner to face the display 58 of the TV apparatus body 40. In this case, the three speakers S1, S2 and S3 are included in a video image which is captured by the camera 61 of the microphone/camera unit 41. The controller 21 calculates the distance between the speakers S2 and S3, for example, based on the positions in the video between the speakers S2 and S3 who are remotest, or the distance from the microphone/camera unit 41 to the speaker S2, S3, which is determined from the video. In the meantime, the distance from the microphone/camera unit 41 to the speaker S2, S3, may be determined by calculations based on the sizes of the objects corresponding to the faces of the speakers, or by equipping the microphone/camera unit 41 with a distance sensor for measuring the distance from the speaker and by receiving detection data of the distance sensor together with video. Besides, the distance between the speakers in the video may be calculated by using other conventional image processing techniques.

When it is determined that the distance between speakers is a preset value or more, the controller 21 instructs, via the communication module 24, the TV apparatus 12 to use the microphone 60, thereby to use the audio, which is input from the microphone 60 of the TV apparatus 12, for the TV phone (block B12). In accordance with the instruction from the mobile information terminal 11, the controller 50 of the TV apparatus 12 executes control to transmit, together with the video, the audio, which is input from the microphone 60, to the mobile information terminal 11 via the communication module 53.

On the other hand, when it is determined that the distance between speakers is not the preset value or more, the controller 21 executes control to input audio from the microphone 32 via the audio input module 31, thereby to use the audio, which is input from the microphone 32 provided in the own apparatus, for the TV phone (block B13).

For example, in FIG. 7, when it is determined that the distance between the speaker S2 and S3 is the preset value or more, that is, in the case where it is difficult to stably input the voice of each speaker by the microphone 32 provided in the mobile information terminal 11, audio is input from the microphone 60 of the TV apparatus 12 so that the TV phone function can be executed.

On the other hand, when it is determined that the distance between the speaker S2 and S3 is not the preset value or more, that is, in the case where the distance between the speaker S2 and S3 is short and it is possible to stably input the voice of each speaker by the microphone 32 provided in the mobile information terminal 11 by positioning the mobile information terminal 11 between the speakers S2 and S3, audio is input from the microphone 32 of the mobile information terminal 11 so that the TV phone function can be executed.

In the above description, the number of speakers is detected based on the video captured by the camera 61 of the TV apparatus 12. However, it is possible to determine the number of speakers, based on the audio which is input by the microphone 60 of the TV apparatus 12 or the microphone 32 of the mobile information terminal 11. For example, the controller 21 detects the difference between speakers by executing an analysis, such as a frequency analysis or voice print determination, with respect to the audio which is input from the microphone 60 or microphone 32. For example, when it is determined that the audio that is input within a predetermined time comprises only the audio that is input from one person, such setting is executed that the microphone 32 of the mobile information terminal 11 is used for the TV phone. When it is determined that the audio that is input within a predetermined time comprises the audio that is input from a plurality of persons (the number of speakers or more, which is designated as the setup condition of “Number of speakers”), such setting is executed that the microphone 60 of the TV apparatus 12 is used for the TV phone.

The method of determining the number of speakers, based on the audio, may be executed in place of the above-described method of determination based on video, or may be executed in combination with the method of determination based on video. In the case of using both the method of determination based on video and the method of determination based audio in combination, even when a plurality of speakers have been detected in the determination of the number of speakers by use of video, if it is determined that the number of speakers who actually utter speech is one, such setting is executed that the microphone 32 of the mobile information terminal 11 is used.

In this manner, when the setup of the microphone which is used for the TV phone has been completed, the controller 21 controls a network connection to the telephone call counterpart via the communication module 26, in accordance with a select instruction for selecting the telephone call counterpart, which is input by a user operation from the operation module 25 (block B14). Then, the controller 21 starts a telephone call by the TV phone. Specifically, the controller 21 transmits the video and audio, which are input by the microphone/camera unit 41, to the telephone call counterpart via the communication module 26, outputs the video and audio, which are received from the telephone call counterpart, to the TV apparatus 12 (TV apparatus body 40), causes the display 58 of TV apparatus body 40 to display the video of the telephone call counterpart, and causes the speaker 56 to output the voice of the telephone call counterpart (block B17).

In addition, the controller 21 causes the display 58 to display a screen D2 for a TV phone, as shown in FIG. 8, which displays, for example, microphone switching buttons. In the example shown in FIG. 8, the screen D2 displays a button C2 for instructing the use of the microphone 60 of the TV apparatus 12, and a button C3 for instructing the use of the microphone 32 of the mobile information terminal 11. The button C2, C3, may be selected, for example, by an operation of the remote controller of the TV apparatus 12, which is detected by the operation module 59, or by an operation of the operation module 25 of the mobile information terminal 11. When the button C2, C3, is selected by the operation of the remote controller, the controller 50 notifies the mobile information terminal 11 via the communication module 53. If a microphone switching instruction is input by selecting the button C2, C3 (Yes in block B15), the controller 21 controls the microphone switching so that either the microphone 60 of the TV apparatus 12 or the microphone 32 of the mobile information terminal 11 may be used for the TV phone in accordance with the selected button (block B16).

Specifically, the TV phone can be executed by arbitrarily effecting switching to either the microphone 60 of the TV apparatus 12 or the microphone 32 of the mobile information terminal 11 by the user operation while a telephone conversation is being made with the telephone call counterpart by the TV phone. For example, each time the number of speakers has increased or decreased while a TV phone call is being made, either the microphone 60 of the TV apparatus 12 or the microphone 32 of the mobile information terminal 11 can be selected by a simple operation in accordance with the number of speakers or the positions (mutual distances) of speakers. Therefore, a telephone call by the TV phone can be made by using the most suitable microphone for the situation.

With the mobile information terminal 11 of the embodiment, a text chat can be performed during a telephone conversion by the TV phone. When the execution of a text chat has been requested, the controller 21 causes the display 30 of the mobile information terminal 11 and the display 58 of the TV apparatus 12 to display a text area for a text chat. When text has been input by an operation on the operation module 25 of the mobile information terminal 11 (Yes in block B18), text data is transmitted to the telephone call counterpart (block B19). In addition, when text data has been received from the telephone call counterpart, the controller 21 causes the text area to display the text from the telephone call counterpart.

As has been described above, even during a telephone conversation by the TV phone, a text chat can be executed in parallel with the TV phone call by operating the mobile information terminal 11. Since the mobile information terminal 11 has the basic input operation function as the information processing terminal, the mobile information terminal 11 can easily execute a text input operation.

In the meantime, such configuration may be adopted that transmission/reception of various data, as well as transmission/reception of text data by a text chat, is executed by the operation of the mobile information terminal 11. For example, transmission/reception of various files may be executed with the telephone call counterpart by the operation of the mobile information terminal 11. In general, the mobile information terminal 11 is provided with a function which can facilitate file operations. Thus, by using this function, file exchange, etc., can be executed with the telephone call counterpart.

When the end of the TV phone is instructed by the user operation from the operation module 25 (Yes in block B20), the controller 21 disconnects the network to the telephone call counterpart, finishes the communication with the TV apparatus 12, and terminates the TV phone function.

In this manner, in the TV phone system 10 of the present embodiment, the TV phone function is realized by cooperatively operating the mobile information terminal 11 and TV apparatus 12. Therefore, the TV phone with high usability can be realized.

Specifically, by using the mobile information terminal 11, various settings and a text chat, which accompanies the TV phone, can easily executed. In addition, in the TV phone, since the video and audio are output by the TV apparatus 12 which has a larger screen size than the mobile information terminal 11, the realistic sensation of the TV phone can be obtained. When the number of speakers who make a telephone call by the TV phone is less than a preset number (e.g. one) or when the distance between a plurality of speakers is short, the microphone 32 that is provided on the mobile information terminal 11 is used for the TV phone. Thereby, since the distance between the speaker 56 of the TV apparatus 12 and the microphone 32 is increased, the occurrence of an echo can surely be suppressed, and the input of noise can be reduced. On the other hand, when the number of speakers is the preset number or more, the voices of the plural speakers can be input with uniform loudness with the use of the microphone 60 of the TV apparatus 12. Thereby, there is no need to position the speakers in consideration of the position of the microphone, and the TV phone can easily be started. Moreover, since the user can select the use of the microphone 60 of the TV apparatus 12 or the use of the microphone 32 of the mobile information terminal 11, the setup according to the condition of use can easily be executed.

In the above description, the TV phone function is realized by cooperatively operating the mobile information terminal 11 and TV apparatus 12. Alternatively, an electronic apparatus, which is other than the TV apparatus 12, and the mobile information terminal 11 may be cooperatively operated.

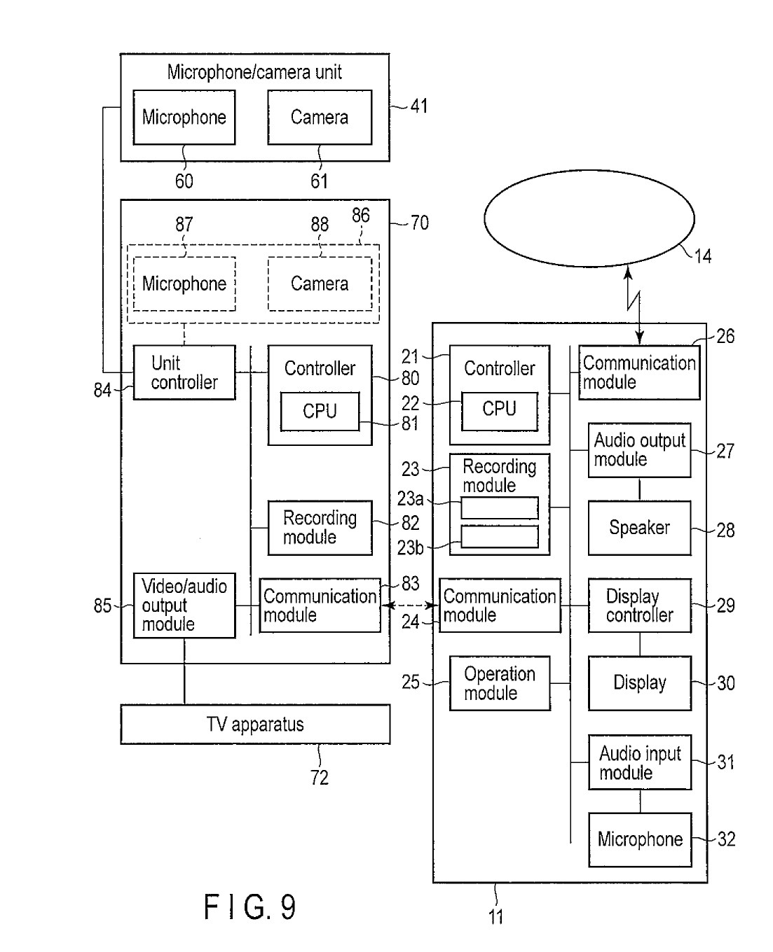

FIG. 9 is an exemplary block diagram illustrating a configuration example for realizing the TV phone system 10 by cooperatively operating the mobile information terminal 11 and a set-top box 70. A detailed description of the parts in FIG. 9, which operate similarly with the structure shown in FIG. 2, is omitted.

The set-top box 70 has a function of causing a TV apparatus 72 to output video and audio which are input from the outside. In addition, like the above-described TV apparatus 12, the set-top box 70 is provided with the function of realizing the TV phone. The set-top box 70 includes a controller 80 (CPU 81), a recording module 82, a communication module 83, a unit controller 84, and a video/audio output module 85.

The controller 80 (CPU 81) controls the entirety of the set-top box 70. The controller 80 executes a TV phone program which is recorded in the recording module 82, thereby realizing a TV phone function in cooperation with the mobile information terminal 11.

The recording module 82 is composed of a memory or the like, and records various programs and various data. In the recording module 82, for example, the TV phone program and various data for controlling the TV phone function are recorded.

The communication module 83 controls communication with the mobile information terminal 11. The communication module 83 communicates with the mobile information terminal 11 (communication module 24), thereby to transmit/receive video and audio.

The unit controller 84 controls the microphone/camera unit 41, and receives video and audio from the microphone/camera unit 41.

The video/audio output module 85 outputs video and audio, which are received from the mobile information terminal 11, to the TV apparatus 72.

Like the TV apparatus 12, the set-top box 70 may be configured to incorporate a microphone/camera unit 86 which includes a microphone 87 and a camera 88.

The operation of the structure shown in FIG. 9 is executed in a substantially similar manner with the operation of the above-described TV apparatus 12, so a detailed description thereof is omitted here.

As has been described above, the TV phone system 10 can be realized by the set-top box 70, as well as the TV apparatus 12, and the mobile information terminal 11. Even in the case of configuring the TV phone system 10 by using the set-top box 70, the same advantageous effects as with the case of using the TV apparatus 12 can be obtained.

The process that has been described in connection with the above-described embodiment may be stored as a computer-executable program (TV phone program) in a recording medium such as a magnetic disk (e.g. a flexible disk, a hard disk), an optical disk (e.g. a CD-ROM, a DVD) or a semiconductor memory, and may be provided to various apparatuses. The program may be transmitted via communication media and provided to various apparatuses. The computer reads the program that is stored in the recording medium or receives the program via the communication media. The operation of the apparatus is controlled by the program, thereby executing the above-described process.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a first microphone configured to receive first audio;
a first communication module configured to receive first video, from a first electronic apparatus, and second audio, the second audio being received by a second microphone from the first electronic apparatus;
a selecting module configured to select either the first audio or the second audio; and
a second communication module configured to transmit, to a second electronic apparatus, the selected audio and the first video, and to receive second video and third audio from the second electronic apparatus;
wherein the first communication module is configured to transmit the second video and the third audio to the first electronic apparatus.

2. The electronic apparatus of claim 1, further comprising a receiver configured to receive an instruction for the selecting module to select either the first audio or the second audio,
wherein the selecting module is configured to select either the first audio or the second audio in accordance with the instruction.

3. The electronic apparatus of claim 1, further comprising a first determination module configured to determine a number of persons appearing in the first video received from the first electronic apparatus,
wherein the selecting module is configured to select either the first audio or the second audio based on the determined number of persons.

4. The electronic apparatus of claim 1, further comprising a second determination module configured to determine a distance between persons appearing in the first video received from the first electronic apparatus,
wherein the selecting module is configured to select either the first audio or the second audio based on the determined distance.

5. The electronic apparatus of claim 1, further comprising a third determination module configured to determine a number of speakers based on the second audio received from the first electronic apparatus,
wherein the selecting module is configured to select either the first audio or the second audio based on the determined number of speakers.

6. The electronic apparatus of claim 1, further comprising a text receiver configured to receive text data,
wherein the second communication module is configured to transmit the text data to the second electronic apparatus.

7. A method of operating a TV phone, the method comprising:
selecting either a first audio, received from a first microphone, or a second audio, received from a second microphone;
receiving first video and the second audio from a first electronic apparatus;
transmitting, to a second electronic apparatus, the selected audio, and the first video;
receiving second video and third audio from the second electronic apparatus; and
transmitting the second video and the third audio to the first electronic apparatus.

8. The method of claim 7, further comprising:
receiving an instruction to select either the first audio or the second audio; and
selecting either the first audio or the second audio in accordance with the instruction.

9. The method of claim 7, further comprising:
determining a number of persons appearing in the video, based on the video received from the first electronic apparatus,; and
selecting either the first audio or the second audio based on the determined number of persons.

10. The method of claim 7, further comprising:
determining a distance between persons appearing in the video based on the first video; and
selecting either the first audio or the second audio based on the determined distance.

11. The method of claim 7, further comprising:
determining a number of speakers based on the second audio; and
selecting either the first audio or the second audio based on the determined number of speakers.

12. The method of claim 7, further comprising:
receiving text data; and
transmitting the text data to the second electronic apparatus.
